(19) United States
(12) Patent Application Publication
(10) Pub. No.: US 2013/0051807 A1
(43) Pub. Date: Feb. 28, 2013

(54) PHOTONIC MILLIMETER-WAVE GENERATOR

(71) Applicants: Chen-Bin Huang, Hsinchu (TW); Jin-Wei Shi, Taoyuan (TW); Ci-Ling Pan, Hsinchu (TW)

(72) Inventors: Chen-Bin Huang, Hsinchu (TW); Jin-Wei Shi, Taoyuan (TW); Ci-Ling Pan, Hsinchu (TW)

(21) Appl. No.: 13/217,005

(22) Filed: Aug. 24, 2011

(51) Int. Cl. H04B 10/04

(52) U.S. Cl. 398/116; 398/182; 398/188; 398/118

(57) ABSTRACT

A photonic millimeter-wave generator capable of combining wired and wireless communication facilities to further elongate the transmission distance comprises a laser generator for generating a first optical signal; an optical frequency comb generator coupled with the laser generator; and a pulse shaper coupled with the optical frequency comb generator. The optical frequency comb generator receives the first optical signal generated by the laser generator and outputs a second optical signal. The second optical signal contains multiple frequency components and is sent to the pulse shaper. The pulse shaper adjusts the amplitude and phase of the second optical signal and then outputs the signal as a third optical signal.

### BACKGROUND OF THE INVENTION

1. Field of the Invention

The present invention relates to a photonic millimeter-wave generator and, more particularly, to a photonic millimeter-wave generator capable of combining wired and wireless communication facilities to further elongate the transmission distance.

2. Description of Related Art

The generation of high repetition-rate optical pulses is playing an important role in high-speed optical fiber and microwave photonics systems. In particular, millimeter-wave (MMW) carriers in the W-band (75-110 GHz) or above are essential to meet the recent demand of gigabits wireless access applications. Due to the relatively higher propagation loss of W-band signal than that of RF bands in free space, radio-over-fiber technology provides an efficient and cost effective way to distribute photonic MMW waveforms from the central office to the base station. Such a scheme has been recently adopted for photonic-assisted MMW carrier generations using optical pulse trains with 100 GHz repetition-rate or higher.

Please refer to FIG. 1, which is a schematic view illustrating a communication system for radio-over-fiber technology. The communication system shown in FIG. 1 is composed of both wired and wireless communication facilities in which fibers 12 are provided for wired transmission and radio signal radiated by base stations 13 are provided for wireless transmission. Signals in optical form, such as optical pulses are first generated within central office 11. The optical signals are then transmitted over fibers 12 to each base station 13, and subsequently converted into radio signals in the base station 13 for wireless broadcasting to the end users near each base station 13.

However, there are three essential requirements, the first is that the width of the initial optical pulse should be short. Second, the repetition-rate of the optical pulses should be very high, and the third is that the dispersion of the fiber links needs to be completely compensated.

As for the width of the pulse, due to high energy signal is desired, short optical pulse is necessary. Further, since the inverse of the temporal interval between two adjacent optical pulses corresponds to the frequency of the radio signal generated by the base station and hence high repetition-rate of the pulse trains is also necessary.

Further, while optical pulses are transmitted over a fiber, distortion is inevitable. The conventional approach to circumvent such dispersion issue is to incorporate a segment of dispersion compensating fiber (DCF) to compensate the accumulated spectral phase of the optical signal delivered over a fiber. With the abovementioned approach, most second-order and partial third-order dispersion of the fiber can be compensated. However, due to the broad optical bandwidth of ultra-short pulses, complete dispersion compensation is essential and remains a challenging task. This issue hinders the realization of a cost-effective radio-over-fiber system, and is one of the major advancement in this disclosure. Further, highly stable ultrahigh-rate short optical pulses may not be generated easily through conventional laser system or direct modulation techniques. On the other hand, the delivery of such short pulses over long optical fiber links also requires careful dispersion control.

Therefore, a scheme capable of simultaneously generating ultra-high rate short optical pulse trains and further delivering these optical pulses over a long fiber distance is of extreme value and is also desired for the industry.

### SUMMARY OF THE INVENTION

The object of the present invention is to provide a photonic millimeter-wave generator capable of combining wired and wireless communication facilities to further elongate the transmission distance.

Another object of the present invention is to provide a photonic millimeter-wave generator capable of generating short optical pulses (less than 1 pico-second duration for each optical pulse), ultra-high repetition-rate optical pulse trains, and delivering the optical pulses over a fiber without distortion.

A further object of the present invention is to provide a method for delivering optical signal over an optical fiber in which the dispersion is eliminated so that the use of dispersion compensating fiber is not required.

In one aspect of the invention, there is provided a photonic millimeter-wave generator, which comprises: a laser generator for generating a first optical signal; an optical frequency comb generator coupled with the laser generator; and a pulse shaper coupled with the optical frequency comb generator The optical frequency comb generator receives the first optical signal generated by the laser generator and outputs a second optical signal. The second optical signal is sent to the pulse shaper, and the pulse shaper outputs a third optical signal.

In another aspect of the invention, there is provided a photonic millimeter-wave generator, which comprises: a laser generator for generating a first optical signal; an optical frequency comb generator coupled with the laser generator; and a pulse shaper coupled with the optical frequency comb generator. The optical frequency comb generator receives the first optical signal generated by the laser generator and outputs a second optical signal. The second optical signal contains multiple frequency components and is sent to the pulse shaper. The pulse shaper adjusts the amplitude and/or the phase of the second optical signal and then outputs the signal as a third optical signal.

In a further aspect of the invention, there is provided a method for delivering optical signal over a fiber, which comprises the steps of: (A) providing an optical signal, the optical signal containing multiple frequency components, each frequency component carrying a phase; (B) separating each frequency component of the optical signal; and (C) imposing a phase to each frequency component of the optical signal; wherein the optical signal is composed of optical pulses.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view illustrating the photonic millimeter-wave generator for radio-over-fiber technology;

FIG. 2 is a schematic view illustrating the photonic millimeter-wave generator in accordance with the first embodiment of the present invention;

FIG. 3 is a schematic view illustrating the photonic millimeter-wave generator in accordance with the second embodiment of the present invention;

FIG. 4a is a schematic view illustrating the pre-compensation phase applied by the pulse shaper;

FIG. 4b is a schematic view illustrating the remaining uncompensated spectral phase;

FIG. 4c is a schematic view illustrating the pre-compensated intensity autocorrelation traces; and

FIG. 5 is a flowchart illustrating the method for delivering optical signal over a fiber in accordance with the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

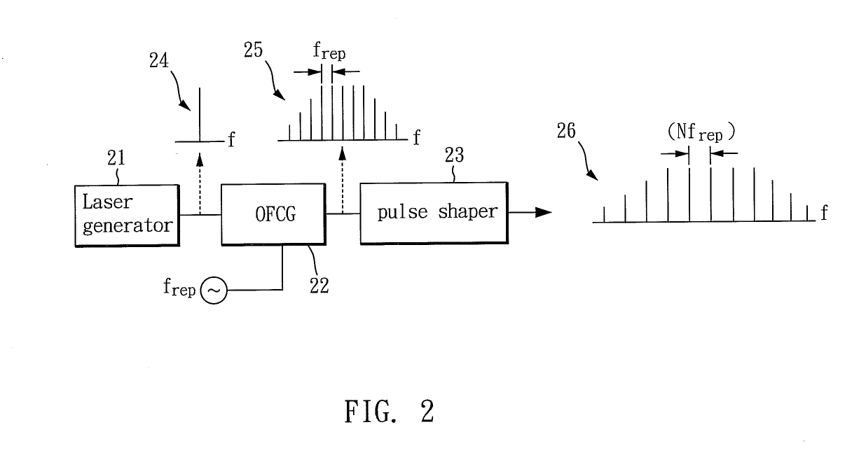

Embodiment 1 of the present invention is disclosed for generating extremely short and ultra high repetition-rate optical pulses. Please refer to FIG. 2, which is a schematic view illustrating the photonic millimeter-wave generator in accordance with the first embodiment of the present invention. As shown in FIG. 2, the photonic millimeter-wave generator of the present invention comprises: a laser generator 21, an optical frequency comb generator 22 (the optical frequency comb generator in the following specification is abbreviated as OFCG), and a pulse shaper 23. The laser generator 21 of this embodiment is preferred to be a continuous wave laser generator (CW laser generator) which generates a first optical signal 24. Further, the first optical signal is a narrow-linewidth CW laser and, as shown in FIG. 2, the first optical signal 24 contains only one single frequency component.

The optical frequency comb generator 22 is coupled with the laser generator 21 for receiving the first optical signal 24. The optical frequency comb generator is for generating optical frequency comb signal. Characteristics and property of optical frequency comb signal are well known to persons of skill in the art and thus relevant description is omitted. However, optical frequency comb generator is preferred to be a phase modulator, a microtoriod cavity, or a phase modulator inside a cavity. Furthermore, the optical frequency comb generator 22 of the present embodiment is a microtoriod cavity. After the first optical signal 24 passes through the optical frequency comb generator 22, the first optical signal 24 with one single frequency component is thus modulated by the optical frequency comb generator 22 then to output a second optical signal 25. As shown in FIG. 2, the second optical signal 25 contains multiple frequency components. Wherein the optical frequency comb generator 22 is driven by a sinusoidal signal with frequency fᵣₑₚ as shown in FIG. 2, which determines the resulting optical frequency comb spacing. For example, fᵣₑₚ is selected to be 25 GHz in this embodiment, which implies that the spacing between two adjacent frequency components of the second optical signal 25 is 25 GHz. However, the spacing between two adjacent frequency components of the second optical signal 25 can be arbitrarily defined within the range between 5 GHz and 50 GHz. The sinusoidal signal of 25 GHz is derived from an ultra-low phase noise radio frequency signal generator and amplified through a power amplifier to derive the optical frequency comb generator.

In addition, the pulse shaper 23 is coupled with the optical frequency comb generator 22 for receiving the second optical signal 25. The pulse shaper 23 of the present invention is preferred to be a free-space pulse shaper, a planar-lightwave circuit pulse shaper, or an acousto-optical pulse shaper. However, the pulse shaper 23 of the present embodiment is an acousto-optical pulse shaper. The spacing between two adjacent frequency components of the second optical signal 25 are multiplied using pulse shaper amplitude control, and then the pulse shaper 23 outputs a signal as a third optical signal 26. As shown in FIG. 2, the spacing between two adjacent frequency components of the third optical signal 26 is N times of that of the second optical signal 25, wherein N is an integer. The third optical signal 26 shown in FIG. 2 is illustrated in the frequency domain, and therefore the spacing between two frequency components is represented by (N fᵣₑₚ). According to the present embodiment, N is about to be 15 and hence the spacing between two adjacent frequency components of the third optical signal 26 is 375 GHz. Since pulse temporal period is the inverse of the repetition frequency, the period of the third optical signal 26 is thus to be (N fᵣₑₚ)⁻¹. According to the above description, the spacing between two adjacent frequency components of the third optical signal 26 is between 100 GHz and 500 GHz. Therefore, ultra-high rate short (less than 1 ps for each optical pulse) optical pulse trains is achieved in the present embodiment.

What should be noticed is, the pulse shaper 23 applies a spectral phase correction setting Φ₀(ωₖ) onto each frequency component of the second optical signal 25 through an automated process maximizing the second-harmonic generation (SHG) yield. Wherein k is an integer, and ωₖ is the frequency offset of the k-th comb line as referenced to the frequency of the first optical signal 24 and, ωₖ=k(2πfᵣₑₚ). Therefore, each frequency component of the second optical signal 25 is made to be in-phase.

### Embodiment 2

Embodiment 2 of the present invention is disclosed for generating extremely short and ultra high repetition-rate optical pulses and further, to deliver the abovementioned optical pulses over a fiber without dispersion compensating fiber.

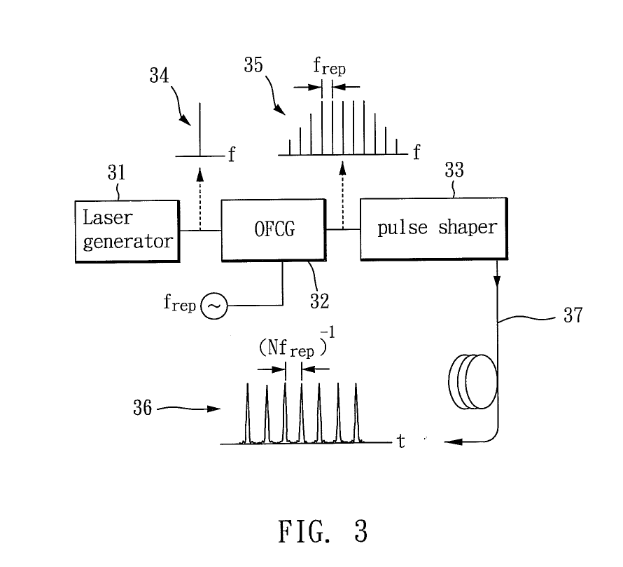

Please refer to FIG. 3, which is a schematic view illustrating the photonic millimeter-wave generator in accordance with the second embodiment of the present invention. As shown in FIG. 3, the photonic millimeter-wave generator of the present invention comprises: a laser generator 31, an optical frequency comb generator 32, and a pulse shaper 33. The laser generator 31 of this embodiment is preferred be a continuous wave laser generator (CW laser generator) which generates a first optical signal 34. Further, the first optical signal is a narrow-linewidth CW laser and, as shown in FIG. 3, the first optical signal 34 contains only one single frequency component.

The optical frequency comb generator 32 is coupled with the laser generator 31 for receiving the first optical signal 34. The optical frequency comb generator 32 of this embodiment is for generating optical frequency comb signal as described in Embodiment 1. Characteristics and property of optical frequency comb signal are well known to persons of skill in the art and thus relevant description is omitted. However, optical frequency comb generator is preferred to be a phase modulator, a microtoriod cavity, or a phase modulator inside a cavity. Furthermore, the optical frequency comb generator 22 of the present embodiment is a phase modulator. After the first optical signal 24 passes through the optical frequency comb generator 32, the first optical signal 34 with one single frequency component is thus modulated by the optical frequency comb generator 32 then to output a second optical signal 35. As shown in FIG. 3, the second optical signal 35 contains multiple frequency components. The optical frequency comb generator 32 is driven by a sinusoidal signal with frequency fᵣₑₚ shown in FIG. 3, which determines the resulting optical frequency comb spacing. Further, fᵣₑₚ is selected to be 31 GHz in this embodiment, which implies that the spacing between two adjacent frequency components of the second optical signal 35 is 31 GHz.

In addition, the pulse shaper 33 is coupled with the optical frequency comb generator 32 for receiving the second optical signal 35. The pulse shaper 33 of this embodiment is to be a free-space pulse shaper and more particularly, a reflective free-space pulse shaper is selected in the present embodiment. Please note that the above mentioned reflective free-space pulse shaper can be superseded by a transmissive free-space pulse shaper. The spacing between two adjacent frequency components of the second optical signal 35 are multiplied by the pulse shaper 23, and then the pulse shaper 33 outputs a signal after spacing doubling as a third optical signal 36. As shown in FIG. 3, the spacing between two adjacent frequency components of the third optical signal 36 is N times of that of the second optical signal 35, wherein N is an integer between 10 and 16. According to the present embodiment, N is about to be 16 and hence the spacing between two adjacent frequency components of the third optical signal 36 is 496 GHz. Since pulse temporal period is the inverse of the repetition frequency, the period of the third optical signal 36 is thus to be (N fᵣₑₚ)⁻¹. Therefore, ultra-high rate short (less than 1 ps for each optical pulse) optical pulse trains is achieved in the present embodiment.

In this embodiment, the third optical signal 36 is then guided into a fiber 37 for being delivered over the fiber 37. The fiber 37 in this embodiment is to be a single-mode fiber. Without the incorporation of dispersion compensating fiber, the pulse shaper 33 adjusts the phase of the second optical signal 35 by the following steps: (A) separating each frequency component of the second optical signal; and (B) imposing a phase to each frequency component of the optical signal.

That is, the difference between Embodiment 2 and Embodiment 1 is that short and ultra high repetition-rate optical pulses is then delivered through an optical fiber without employment of dispersion compensating fiber. For this, the second optical signal 35 introduced to the pulse shaper 33 is first to be separated by a grating (not shown in the figure) which is installed inside the pulse shaper 33, as described in step (A). The grating is a gold-coated grating of the present embodiment but not limited to. Any other sort of grating capable of separating optical signal is suitable for the present invention.

As the frequency components of the second optical signal 35 are separated, each frequency component can thus be controlled independently. After then, each frequency component is sent to a spatial light modulator (SLM, not shown in the figure) which is installed inside the pulse shaper 33 as well. The SLM then imposes a phase to each frequency components as described in step (B).

For persons of skill in the art may known, the accumulated spectral phase for a given optical fiber length is expressed as exp[jΦ_{f}(ωₖ)]. Further, the nonlinear SMF spectral phase sampled by the discrete comb lines can be approximated using the Taylor series expansion as the following equation:

Φ_{f,NL}(ωₖ)=−(β₂ωₖ²/2+β₃ωₖ³/6)L (equation 1);

where Φ_{f,NL}(ωₖ) represents the nonlinear SMF spectral phase sampled by discrete comb lines, β₂ and β₃ denotes the second order and the third order derivatives of the propagation constant with respect to the center frequency respectively. Moreover, L represents the length for the given optical fiber. It is well known that the quadratic (β₂) term broadens the pulse and the cubic (β₃) term causes fast pulse oscillatory tails.

Additionally, in order to facilitate quantitative investigations, the spectral phase sampled by the comb lines in equation 1 is formulated as the sum of modulo of 2π and, a remainder phase Φᵣₑₘ(ωₖ), which is then written as the following equation:

Φ_{f,NL}(ωₖ)=Nₖ2π+Φᵣₑₘ(ωₖ) (equation 2);

where Nₖ is the corresponding integer modulus for the k-th comb line, and Φᵣₑₘ(ωₖ) is between [0, 2π].

Furthermore more, in order to restore the initial pulse intensity waveform and periodicity at the transmission end of the fiber, a dispersion pre-compensation phase setting of:

Φ_{pc}(ωₖ)==Φᵣₑₘ(ωₖ) (equation 3);

Φ_{pc}(ωₖ) is applied by the SLM installed in the pulse shaper. Therefore, the total phase applied in this embodiment by the SLM is to be Φ_{LCM}(ωₖ)=Φ₀(ωₖ)+Φ_{pc}(ωₖ). Wherein Φ_{pc}(ωₖ) is the dispersion pre-compensation phase applied by the LCM.

The pulse shaper applies a phase to each frequency component of the second optical signal and outputs as the third optical signal, the third optical signal is then guided into the single-mode fiber. It is worth to note that the phase of each frequency after the fiber based on the above description and equations is evaluated as Φ_{pc}(ωₖ)+Φ_{f,NL}(ωₖ), and which is to be Nₖ2π after evaluation.

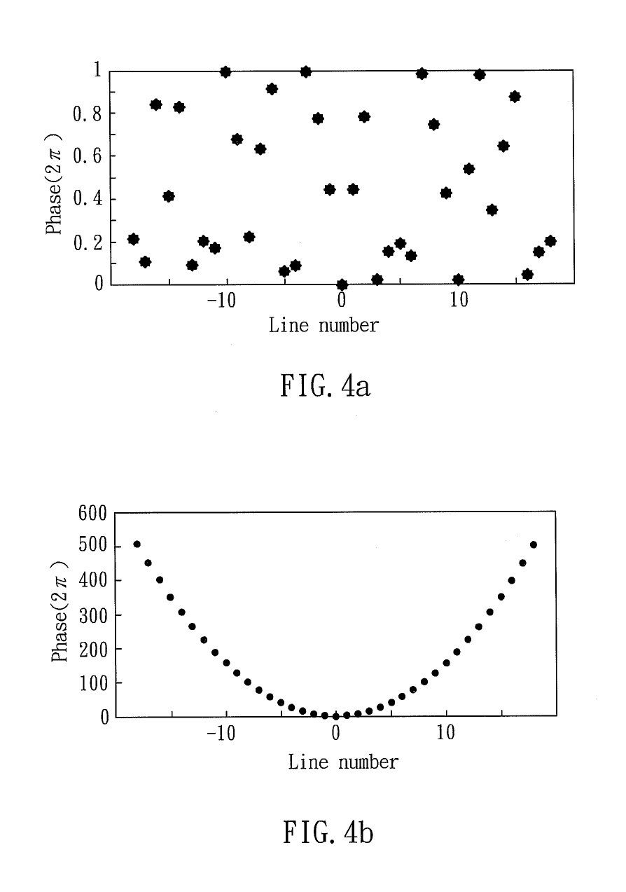

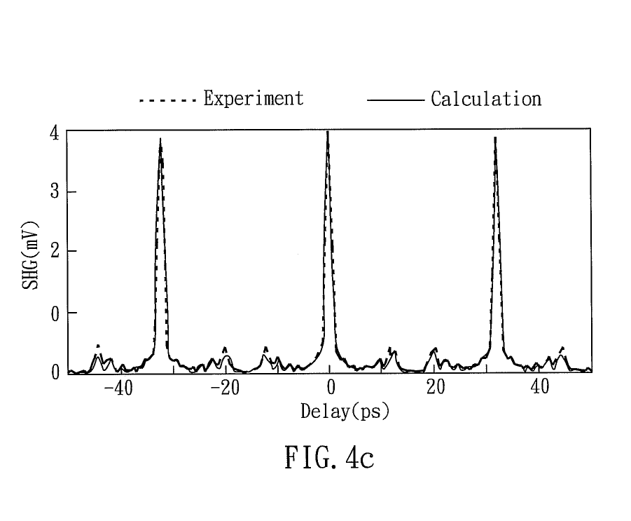

Please refer to FIG. 4a, FIG. 4a is a schematic view illustrating the pre-compensation phase applied by the pulse shaper, wherein the pre-compensation phase applied by the LCM is applied onto each of the frequency component of the second optical signal in units of 2π. Moreover, refer to FIG. 4b, FIG. 4b is a schematic view illustrating the remaining uncompensated spectral phase, wherein the spectral phase is in units of 2π. That is, Nₖ for each corresponding frequency component. It is evident that the remaining uncompensated phases result in a large quadratic phase and thus leads to huge pulse broadening that leads to the temporal self-imaging. Please refer to FIG. 4c simultaneously; FIG. 4c is a schematic view illustrating the pre-compensated intensity autocorrelation traces. As shown in FIG. 4c, comparison between the experimental (represented in dot) and calculated (represented in solid) traces reveal that the optical pulses are restored perfectly. It is also evident that such approach is an excellent platform for remote delivery of ultrahigh-rate optical signals.

Please note that, 37 dots illustrated in FIG. 4a and FIG. 4b represents 37 comb lines is contained in the second optical signal, but not constraints to only 37 comb lines. Optical signal with any number of comb lines can be restored perfectly according to the pre-compensated mechanism mentioned above.

According to the consequence of the evaluation, it implies that for the fiber delivery, the pulse shaper applied a extra phase to each frequency component and each frequency component sees N2π phase after the fiber.

According to the above description, optical signal delivered over an optical fiber in which the dispersion being eliminated is achieved and therefore ultra-high rate short optical pulse trains and further to deliver these optical pulses over a long fiber distance is accomplished simultaneously.

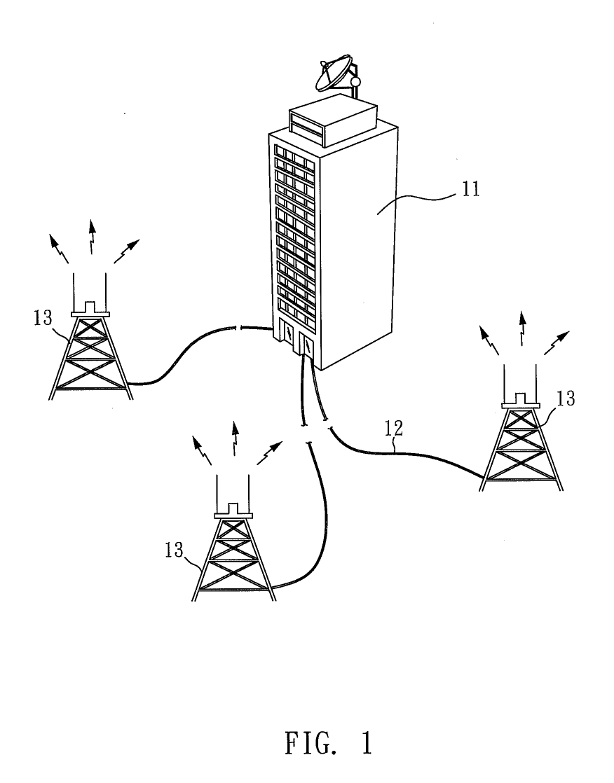

With reference to FIG. 1 simultaneously, perfect ultra-high rate short optical pulse trains is required for base station 13 to generate millimeter wave. That is, again, how to delivery the ultra-high rate short optical pulses generated within the central office 11 through the fiber 37 without dispersion compensating fiber is of desired and achieved by the present invention.

The laser generator 31, the optical frequency comb generator 32, and the pulse shaper 33 can be arranged in the central office 11, and the fiber 37 shown in FIG. 3 is considered as the fiber 12 shown in FIG. 1. The optical pulses that generated within the central office 11 and adjusted by the abovementioned phase adjustment mechanism are delivered through the fiber 12 from the central office 11 to each base station 13. Each base station 13 then converts the optical signal into radio signal via an optical-to-electrical converter and, the radio signal is then broadcasted to the end users near each base station 13. Moreover, the radio signal is a millimeter wave signal and the generation thereof is done due to perfect optical pulses is provided, according to the dispersion pre-consumption phase mechanism mentioned above. The optical-to-electrical converter is disposed in each base station 13 for converting the optical signal into radio signal. The form of the optical-to-electrical converter is not limited, but for the present embodiment, the optical-to-electrical converter is to be a photodetector.

What should be noticed is that optical pulses adjusted by the abovementioned phase adjustment mechanism can be self-imaged by themselves at the transmission end of the fiber, and thus the optical pulses are reconstructed perfectly to meet the same waveform as what it is to be from the central office. This implies that the dispersion that occurred while optical signal is transmitted over a fiber is eliminated and further infers that dispersion compensating fiber is no longer needed.

With the disclosure of the second embodiment of the present invention, in addition to short linewidth and ultra high repetition-rate optical pulses is achieved, the optical pulses is further able to be delivered over a fiber with arbitrary length without dispersion compensating fiber according to the abovementioned phase adjustment mechanism.

### Method for Delivering Optical Signal Over a Fiber

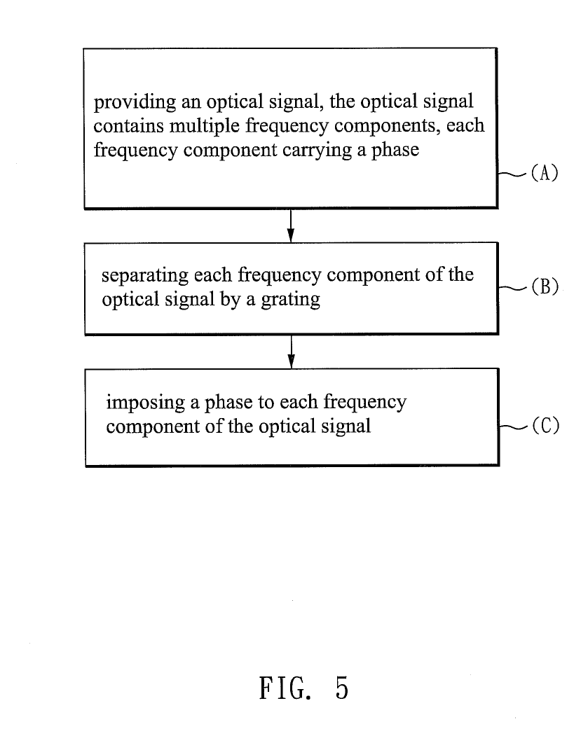

Please refer to FIG. 5, which is a flowchart illustrating the method for delivering optical signal over a fiber in accordance with the present invention. The method for delivering optical signal over a fiber comprises the following steps: (A) providing an optical signal, the optical signal containing multiple frequency components, each frequency component carrying a phase; (B) separating each frequency component of the optical signal; and (C) imposing a phase to each frequency component of the optical signal; wherein the optical signal is composed of optical pulses.

That is, the original optical signal provided in step (A) is composed of optical pulses, and each optical pulse carries different phase. Furthermore, in step (B), each frequency component is separated by a grating. Besides, each frequency component is compensated with a corresponding phase. Additionally, the method further comprises a step (D) for guiding the optical signal after adjusting into a fiber after step (C), letting the phase of each frequency component to be N(2π) after the fiber. The optical pulses adjusted by the abovementioned phase adjustment mechanism are self-imaged by themselves at the transmission end of a fiber, and thus the optical pulses are reconstructed perfectly to meet with the same waveform as what it is to be from the central office. This implies that the dispersion that occurred while optical signal is transmitted over a fiber is eliminated and further infers that dispersion compensating fiber is no longer needed. Principles of the method for delivering optical signal over a fiber are the same as depicted in Embodiment 2 and hence being omitted here.

With the disclosure of the method of the present invention, optical pulses is able to be delivered over a fiber with arbitrary length without dispersion compensating fiber for dispersion compensation.

With the description accompanied by the figures, ultra-high rate short optical pulse trains and further to deliver these optical pulses over a long fiber distance is accomplished simultaneously. Further, wired and wireless communication facilities are associated and thus far more long transmission distance is achieved.

Although the present invention has been explained in relation to its preferred embodiment, it is to be understood that many other possible modifications and variations can be made without departing from the spirit and scope of the invention as hereinafter claimed.

What is claimed is:

1. A photonic millimeter-wave generator comprising:
a laser generator for generating a first optical signal;
an optical frequency comb generator coupled with the laser generator; and
a pulse shaper coupled with the optical frequency comb generator,
wherein the optical frequency comb generator receives the first optical signal generated by the laser generator and outputs a second optical signal, the second optical signal is sent to the pulse shaper, and the pulse shaper outputs a third optical signal.

2. The photonic millimeter-wave generator as claimed in claim 1, wherein the optical frequency comb generator is a phase modulator, a microtoriod cavity, or a phase modulator inside a cavity.

3. The photonic millimeter-wave generator as claimed in claim 1, wherein the pulse shaper is a free-space pulse shaper, a planar-lightwave circuit pulse shaper, or an acousto-optical pulse shaper.

4. The photonic millimeter-wave generator as claimed in claim 3, wherein the free-space pulse shaper is a transmissive free-space pulse shaper, or a reflective free-space pulse shaper.

5. The photonic millimeter-wave generator as claimed in claim 1, wherein the laser generator is a continuous wave laser generator.

6. The photonic millimeter-wave generator as claimed in claim 1, wherein the second optical signal contains multiple frequency components, and the spacing between two adjacent frequency components is between 5 GHz and 50 GHz.

7. The photonic millimeter-wave generator as claimed in claim 1, wherein the third optical signal contains multiple frequency components, and the spacing between two adjacent frequency components is between 100 GHz and 500 GHz.

8. A photonic millimeter-wave generator comprising:
a laser generator for generating a first optical signal;
an optical frequency comb generator coupled with the laser generator; and
a pulse shaper coupled with the optical frequency comb generator,
wherein the optical frequency comb generator receives the first optical signal generated by the laser generator and outputs a second optical signal, the second optical signal contains multiple frequency components and is sent to the pulse shaper, the pulse shaper adjusts the phase of the second optical signal and then outputs the signal as a third optical signal.

9. The photonic millimeter-wave generator as claimed in claim 8, wherein the photonic millimeter-wave generator further comprises an optical fiber and an optical-to-electrical converter, the two ends of the optical fiber are coupled with the pulse shaper and the optical-to-electrical converter.

10. The photonic millimeter-wave generator as claimed in claim 9, wherein the optical fiber is a single-mode optical fiber.

11. The photonic millimeter-wave generator as claimed in claim 9, wherein the optical-to-electrical converter is a photodetector.

12. The photonic millimeter-wave generator as claimed in claim 8, wherein the pulse shaper adjusts the phase of the second optical signal by the following steps:
separating each frequency component of the second optical signal; and
imposing a phase to each frequency component of the second optical signal.

13. The photonic millimeter-wave generator as claimed in claim 12, wherein the frequency components are separated by a grating.

14. The photonic millimeter-wave generator as claimed in claim 13, wherein the grating is a gold-coated grating.

15. The photonic millimeter-wave generator as claimed in claim 8, wherein the optical frequency comb generator is a phase modulator, a microtoriod cavity, or a phase modulator inside a cavity.

16. The photonic millimeter-wave generator as claimed in claim 8, wherein the pulse shaper is a free-space pulse shaper, a planar-lightwave circuit pulse shaper, or an acousto-optical pulse shaper.

17. The photonic millimeter-wave generator as claimed in claim 16, wherein the free-space pulse shaper is a transmissive free-space pulse shaper, or a reflective free-space pulse shaper.

18. The photonic millimeter-wave generator as claimed in claim 8, wherein the laser generator is a continuous wave laser generator.

19. The photonic millimeter-wave generator as claimed in claim 8, wherein the second optical signal contains multiple frequency components, and the spacing between two adjacent frequency components is between 5 GHz and 50 GHz.

20. The photonic millimeter-wave generator as claimed in claim 8, wherein the third optical signal contains multiple frequency components, and the spacing between two adjacent frequency components is between 100 GHz and 500 GHz.

21. A method for delivering optical signal over a fiber comprising the steps of
(A) providing an optical signal, the optical signal containing multiple frequency components, each frequency component carrying a phase;
(B) separating each frequency component of the optical signal; and
(C) imposing a phase to each frequency component of the optical signal;
wherein the optical signal is composed of optical pulses.

22. The method for delivering optical signal over a fiber as claimed in claim 21, further comprising a step (D) for guiding the optical signal after imposing into an optical fiber.

23. The photonic millimeter-wave generator as claimed in claim 21, wherein the frequency components are separated by a grating.

24. The photonic millimeter-wave generator as claimed in claim 23, wherein the grating is a gold-coated grating.
